(19) United States
(12) Patent Application Publication
(10) Pub. No.: US 2024/0275640 A1
(43) Pub. Date: Aug. 15, 2024

(54) MULTI-USER MULTIPLE INPUT MULTIPLE OUTPUT (MU-MIMO) RESTRICTION WITH ENHANCED DEMODULATION REFERENCE SIGNAL (DMRS) CONFIGURATION TYPES FOR PDSCH IN NEW RADIO (NR)

(71) Applicant: Apple Inc., Cupertino, CA (US)

(72) Inventors: Ankit BHAMRI, Bad Nauheim (DE); Dawei ZHANG, Saratoga, CA (US); Haitong SUN, Cupertino, CA (US); Wei ZENG, Saratoga, CA (US); Chunxuan YE, San Diego, CA (US)

(73) Assignee: Apple Inc., Cupertino, CA (US)

(21) Appl. No.: 18/523,147

(22) Filed: Nov. 29, 2023

Related U.S. Application Data
(60) Provisional application No. 63/445,870, filed on Feb. 15, 2023.

(51) Int. Cl. H04L 25/02; H04B 17/336; H04W 8/22

(52) U.S. Cl. CPC H04L 25/0222; H04B 17/336; H04W 8/22

(57) ABSTRACT

Aspects are described for a user equipment (UE) comprising a transceiver configured to enable wireless communication with a base station, and a processor communicatively coupled to the transceiver. The processor is configured to receive a configuration message from the base station and determine a first set of antenna ports based on the configuration message. The processor is further configured to perform channel estimation on the first set of antenna port and perform or refrain from performing channel estimation on a second set of antenna ports based on the configuration message. The first set of antenna ports and the second set of antenna ports are in a code division multiplexing (CDM) group.

### BACKGROUND

This application claims the benefit of U.S. Provisional Application No. 63/445,870 filed Feb. 15, 2023, titled “MULTI-USER MULTIPLE INPUT MULTIPLE OUTPUT (MU-MIMO) RESTRICTION WITH ENHANCED DEMODULATION REFERENCE SIGNAL (DMRS) CONFIGURATION TYPES FOR PDSCH IN NEW RADIO (NR),” the content of which is herein incorporated by reference in its entirety.

### BACKGROUND

### Field

The described aspects generally relate to a reference signal configuration procedure for new radio (NR) systems.

### SUMMARY

Some aspects of this disclosure relate to systems, apparatuses, and methods for implementing a reference signal configuration procedure for NR systems. For example, the systems, the apparatuses, and the methods are provided for assigning antenna ports of a code division multiplexing (CDM) group to one or more user equipment (UE).

Some aspects of this disclosure relate to a UE comprising a transceiver configured to enable wireless communication with a base station, and a processor communicatively coupled to the transceiver. The processor is configured to receive a configuration message from the base station and determine a first set of antenna ports based on the configuration message. The processor is further configured to perform channel estimation on the first set of antenna port and perform or refrain from performing channel estimation on a second set of antenna ports based on the configuration message. The first set of antenna ports and the second set of antenna ports are in a CDM group.

Some aspects of this disclosure relate to a method of operating a UE. The method comprises receiving a configuration message from the base station and determining a first set of antenna ports based on the configuration message. The method further comprises performing channel estimation on the first set of antenna ports and performing or refraining from performing channel estimation on a second set of antenna ports based on the configuration message. The first set of antenna ports and the second set of antenna ports are in a CDM group.

Some aspects of this disclosure relate to a base station comprising a transceiver configured to enable wireless communication with a first UE and a second UE and a processor communicatively coupled to the transceiver. The processor is configured to receive a capability report from the first UE and generate a configuration message based on the capability report. The configuration message assigns a first set of antenna ports to the first UE and assigns a second set of antenna ports to the second UE or be vacant. The first and the second sets of antenna ports are in a CDM group. The processor is further configured to transmit, using the transceiver, the configuration message to the first UE.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a reference signal configuration procedure for NR systems, according to some aspects of the disclosure.

FIG. 2 illustrates a block diagram of an example system of an electronic device for the reference signal configuration procedure, according to some aspects of the disclosure.

FIG. 3 illustrates an example of a type 1 reference signal configuration, according to aspects of the disclosure.

FIG. 4 illustrates an example of a type 2 reference signal configuration, according to aspects of the disclosure.

FIGS. 5A and 5B illustrate examples of an enhanced type 1 reference signal configuration, according to aspects of the disclosure.

FIGS. 6A and 6B illustrate examples of an enhanced type 2 reference signal configuration, according to aspects of the disclosure.

FIG. 7 illustrates an example of a legacy configuration table and a new configuration table.

FIG. 8 illustrates an example method of the reference signal configuration procedure at a UE, according to aspects of the disclosure.

FIG. 9 illustrates an example method of performing channel estimation, according to aspects of the disclosure.

FIG. 10 illustrates an example method of the reference signal configuration procedure at a base station, according to aspects of the disclosure

FIG. 11 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for implementing a reference signal configuration procedure for NR systems. For example, the systems, the apparatuses, and the methods are provided for assigning antenna ports of a CDM group to one or more UEs.

In some aspects, a base station can transmit various reference signals to a UE. For example, the base station can transmit a channel state information reference signal (CSI-RS) to the UE. The UE can estimate channel state information between the base station and the UE and report the channel state information back to the base station. The base station then adjusts transmissions to the UE based on the channel state information. For another example, the base station can transmit demodulation reference signals (DMRS) alongside data to the UE. The UE can demodulate the data using the DMRS received. For example, the UE can estimate the channel state information, correct phase and frequency distortions, and recover information symbols carried in the data using the DMRS.

In some aspects, the DMRS are specific to the UE, e.g. a first UE. For example, the base station can assign a first set of one or more resource elements to the first UE. In such a case, the base station can transmit a first set of DMRS in the first set of one or more resource elements to the first UE. Likewise, the base station can assign a second set of one or more resource elements to a second UE. Therefore, the base station can transmit a second set of DMRS in the second set of one or more resource elements to the second UE. Because the first set of DMRS and the second set of DMRS are transmitted in different resource elements, they do not interfere with each other. In some aspects, the first set of one or more resource elements corresponds to a first antenna port and the second set of one or more resource elements corresponds to a second antenna port. In an example, per 3GPP TS 36.211, “[a]n antenna port is defined such that the channel over which a symbol on the antenna port is conveyed can be inferred from the channel over which another symbol on the same antenna port is conveyed. There is one resource grid per antenna port.” TS 36.212, v. 17.2.0, p. 20.) Accordingly, an antenna port can be a logical construct, separate from a physical antenna, and represented by one or more DMRS. The base station can transmit the first set of DMRS and data to the first UE using the first antenna port. In such a case, the first UE can assume that the first set of DMRS and the data experience same channel conditions because they are both transmitted via the first antenna port. Thus, the first UE can demodulate the data using the first set of DMRS received via the first antenna port from the base station.

In some aspects, the base station can assign resource elements to a plurality of UEs. For example, the base station can further assign the first set of one or more resource elements to a third UE. In other words, the first UE and the third UE share the first set of one or more resource elements. In such a case, the base station can transmit the first set of DMRS to the first UE and a third set of DMRS to the third UE in the first set of one or more resource elements. To distinguish the first set of DMRS and the third set of DMRS, the base station can apply orthogonal cover codes (OCC) to the first set of DMRS and the third set of DMRS. For example, the base station can apply a first OCC to the first set of DMRS and apply a second OCC to the third set of DMRS. The first UE can recover the first set of DMRS using the first OCC and the third UE can recover the third set of DMRS using the second OCC. In this way, the base station multiplexes the first set of DMRS and the third set of DMRS in the first set of one or more resource elements using the first and the second OCC. In some aspects, even though the first UE and the third UE share resource elements, they are assigned different antenna ports because they are assigned with different OCC. For example, the first UE is assigned with the first antenna port and the third UE is assigned with a third antenna port. Here, the first antenna port and the third antenna port both correspond to the first set of one or more resource elements, but they correspond to different OCC.

In some aspects, antenna ports sharing resource elements, such as the first antenna port and the third antenna port discussed above, are in a CDM group. A number of antenna ports in a CDM group is limited. For example, in LTE systems, a DMRS of configuration type 1 with 1 symbol can support 2 antenna ports in a same CDM group. In 5G NR systems, more antenna ports are supported. For example, an enhanced DMRS of configuration type 1 with 1 symbol can support 4 antenna ports. In some aspects, the additional 2 antenna ports are supported with additional OCC. For example, the additional OCC can have different patterns or a different length. In some aspects, the base station can assign the 2 antenna ports supported in LTE systems to the first UE. The first UE can estimate channel information of the 2 antenna ports using DMRS transmitted via the 2 antenna ports. The base station can also assign the additional 2 antenna ports supported in 5G NR systems to the third UE. The first UE can estimate interference of the additional 2 antenna ports using additional DMRS received via the additional 2 antenna ports. In such a case, the first UE is required to determine the additional OCC, detect the additional DMRS using the additional OCC, and/or estimate channel information of the additional 2 antenna ports.

In some aspects, the base station can determine whether to assign the additional 2 antenna ports to the third UE based on capability of the first UE. For example, the first UE can report its capability to the base station. In some aspects, the first UE's capability can be 0 or default. In such a case, the first UE is not capable of determining the additional OCC, detecting the additional DMRS, or estimating interference of the additional antenna ports. Thus, the base station can assign the additional 2 antenna ports to be vacant. The first UE can then assume that no other UEs are assigned with the additional 2 antenna ports and refrain from performing channel estimation on the additional 2 antenna ports. In some aspects, the first UE's capability can be 1 or 2. In such a case, the first UE is capable of determining the additional OCC, detecting the additional DMRS, and estimating interference of the additional 2 antenna ports. Thus the base station can assign the additional 2 antenna ports to the third UE or other UEs.

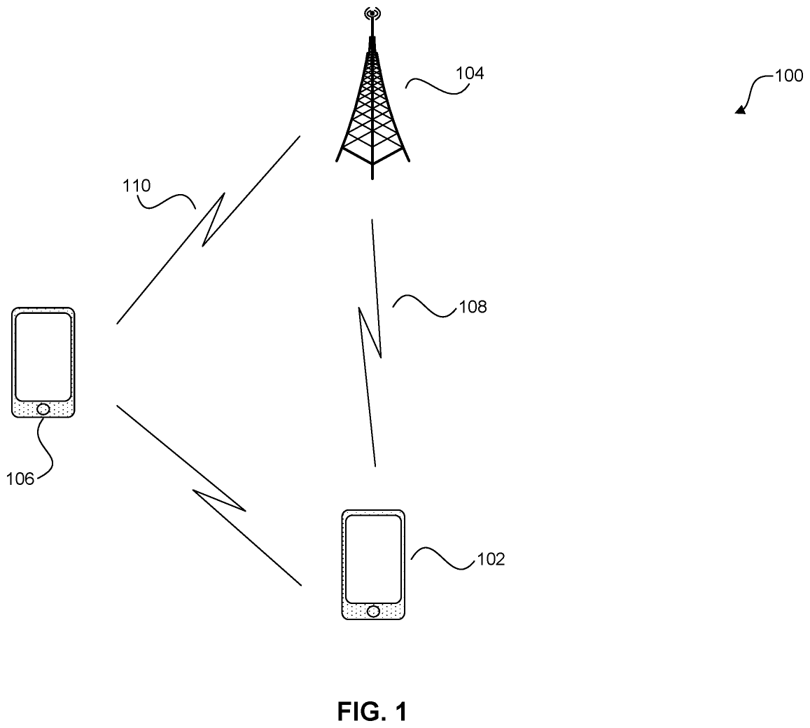

FIG. 1 illustrates an example system 100 implementing a reference signal configuration procedure for NR systems, according to some aspects of the disclosure. The example system 100 is provided for the purpose of illustration only and does not limit the disclosed aspects. The example system 100 may include, but is not limited to, a UE 102, a UE 106, and a base station 104. The UEs 102 and 106 may be implemented as electronic devices configured to operate based on a wide variety of wireless communication techniques. These techniques may include, but are not limited to, techniques based on 3rd Generation Partnership Project (3GPP) standards. For example, the UEs 102 and 106 be configured to operate using one or more 3GPP releases, such as Release 15 (Rel-15), Release 16 (Rel-16), Release 17 (Rel-17), Release 18 (Rel-18), or other 3GPP releases. The UEs 102 and 106 may include, but is not limited to, wireless communication devices, smartphones, laptops, desktops, tablets, personal assistants, monitors, televisions, wearable devices, Internet of Things (IoT) devices, vehicle communication devices, and the like. The base station 104 may include one or more nodes configured to operate based on a wide variety of wireless communication techniques such as, but not limited to, techniques based on the 3GPP standards. For example, the base station 104 may include nodes configured to operate using Rel-15, Rel-16, Rel-17, Rel-18, or other 3GPP releases. The base station 104 may include, but not limited to, NodeBs, eNodeBs, gNBs, new radio base stations (NR BSs), access points (APs), remote radio heads, relay stations, and others.

In some aspects, the UE 102 connects with the base station 104 via a communication link 108. The communication link 108 can include uplink (UL) connections and downlink (DL) connections. In some aspects, the base station 104 can assign a first and a second antenna ports to the UE 102. Thus, the base station can transmit first DMRS and first data via the first and the second antenna ports to the UE 102 using the communication link 108. The UE 102 can demodulate the first data using the first DMRS. In some aspects, the UE 106 connects with the base station 104 via a communication link 110. The communication link 110 can include UL connections and DL connections. The base station 104 can assign a third and a fourth antenna ports to the UE 106. Thus the base station can transmit second DMRS and second data via the third and the fourth antenna ports to the UE 106 using the communication link 110. Similar to the UE 102, the UE 106 can demodulate the second data using the second DMRS.

In some aspects, the first and the third antenna ports are in a CDM group. Similarly, the second and the four antenna ports are in a second CDM group. Thus, the first and third antenna ports share resource elements and the second and the fourth antenna ports also share resource elements. In such a case, the UE 102 receive the first DMRS and the first data along with the second DMRS and the second data. The UE 102 can distinguish the first DMRS and the first data from the second DMRS and the second data using OCC applied. For example, the base station 104 can apply first OCC to the first DMRS and the first data and apply second OCC to the second DMRS and the second data.

In some aspects, the UE 102 may not be able to determine the second OCC. For example, the second OCC may have a different length or a different format compared with the first OCC. In such a case, the UE 102 can report a capability 0 or a default capability to the base station 104. The base station 104 can then assign a fifth and a sixth antenna ports to the UE 106 instead of the third and the fourth antenna ports. The fifth and the sixth antenna ports can be in a third CDM group. Thus, when the UE 102 receives the first DMRS and the first data via the first and the second antenna ports, the UE 102 can assume that no other signals are to be received via the third and the fourth antenna ports. In such a case, the UE 102 does not need to determine the second OCC or perform channel estimation on the third and the fourth antenna ports. In some aspects, the UE 102 may be capable of determining the second OCC. In such a case, the UE can report capability 1 or capability 2 to the base station 104. The base station can assign the third and the fourth antenna ports to the UE 106.

In some aspects, the base station 104 configures the UE 102 using a configuration message. For example, the base station 104 can transmit the configuration message to the UE 102 via the communication link 108. The configuration message can indicate the first and the second antenna ports. In other aspects, the UE 102 can be configured with an antenna port configuration table, which includes one or more entries that each includes one or more antenna ports. The configuration message can indicate an entry of the antenna port configuration table that includes the first and the second antenna ports.

In some aspects, the UE 102 can assume that the base station 104 assigns antenna ports based on the capability reported to the base station 104. For example, the UE 102 may report the capability 0 to the base station 104. The UE 102 may receive the configuration message indicating the first and the second antenna ports are assigned to UE 102. In such a case, the UE 102 can assume that the base station 104 assigns the fifth and the sixth antenna ports to the UE 106. In other words, the third and the fourth antenna ports are not assigned to any other UEs. In some aspects, the base station 104 can overwrite the capability reported to the UE 102. For example, the UE 102 is capable of determining the second OCC and thus the UE 102 can report the capability 1. However, the base station 104 can transmit a second configuration message to the UE 102 via the communication link 108. The second configuration message may indicate that the third and the fourth antenna ports are not assigned to other UEs. In such a case, although the UE 102 is capable of determining the second OCC and performing interference estimation, the UE 102 may not need to do so.

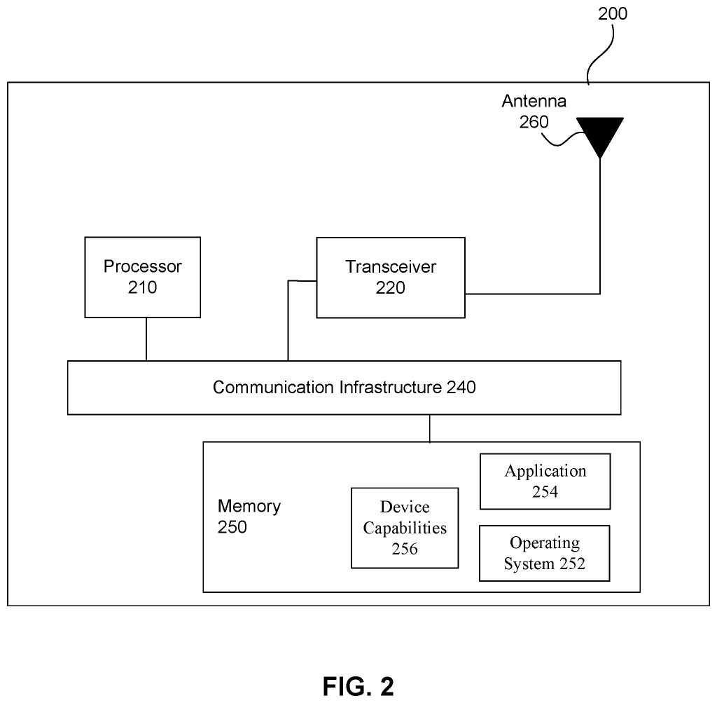

FIG. 2 illustrates a block diagram of an electronic device 200 implementing the reference signal configuration procedure, according to some aspects of the disclosure. The electronic device 200 may be any of the electronic devices (e.g., the UEs 102, 106, and the base station 104) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The applications in the application 254 may include applications such as, but not limited to, radio streaming, video streaming, remote control, and/or other user applications. In some aspects, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for the reference signal configuration procedure, as described herein. Alternatively, or additionally, the processor 210 can be “hard coded” to implement mechanisms for the reference signal configuration procedure, as described herein.

The one or more transceivers 220 transmit and receive communications signals support mechanisms for the reference signal configuration procedure. Additionally, the one or more transceivers 220 transmit and receive communications signals that support mechanisms for measuring communication link(s), generating and transmitting system information, and receiving the system information. According to some aspects, the one or more transceivers 220 may be coupled to the antenna 260 to wirelessly transmit and receive the communication signals. The antenna 260 may include one or more antennas that may be the same or different types and can form one or more antenna ports. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver.

Additionally, the one or more the transceivers 220 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the one or more transceivers 220 may be configured to operate according to one or more of Rel-15, Rel-16, Rel-17, Rel-18, or other releases of 3GPP standard.

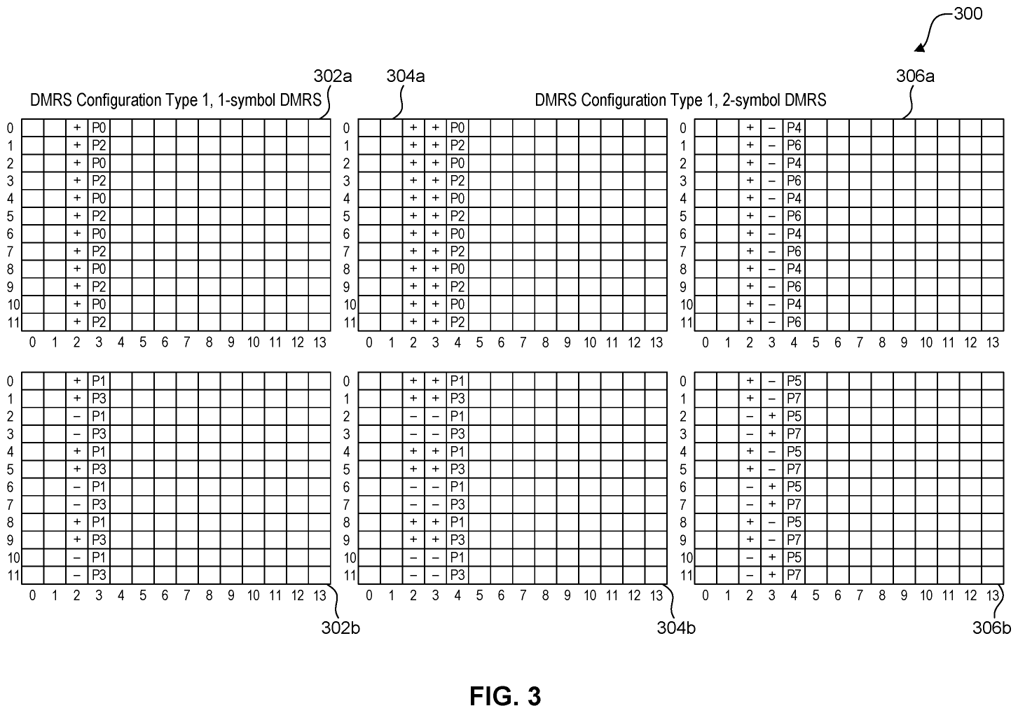

As discussed in more detail below with respect to FIGS. 3-11, processor 210 may implement different mechanisms for the reference signal configuration procedure as discussed with respect to the system 100 of FIG. 1.

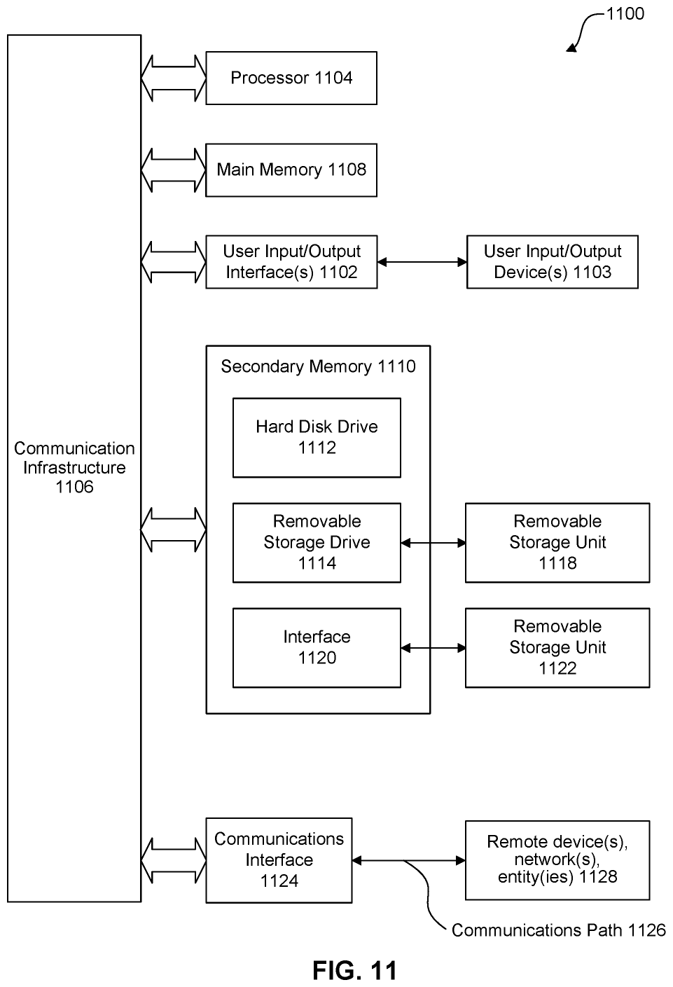

FIG. 3 illustrates an example 300 of a type 1 reference signal configuration. The example 300 is provided for the purpose of illustration only and does not limit the disclosed aspects. As a convenience and not a limitation, FIG. 3 may be described with regard to elements of FIGS. 1, 2, and 11. The example 300 may represent the operation of electronic devices (for example, the UEs 102, 106, and the base station 104 of FIG. 1) implementing the reference signal configuration procedure. The example 300 may also be performed by the electronic device 200 of FIG. 2, controlled or implemented by processor 210, and/or computer system 1100 of FIG. 11. But the example 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

In some aspects, the example 300 includes resource tables 302a and 302b that illustrate DMRS configuration in two resource blocks for DMRS configuration type 1 with 1 symbol. Specifically, the two resource blocks include 12 subcarriers (on the vertical axis) and 14 symbols (on the horizontal axis), as shown in each of 302a and 302b. Thus, the two resource blocks include a total of 168 resource elements. In some aspects, a base station, such as the base station 104, can assign the subcarriers to multiple antenna ports. For example, the resource table 302a shows that subcarriers 0, 2, 4, 6, 8, and 10 are assigned to an antenna port 0 and subcarriers 1, 3, 5, 7, 9, and 11 are assigned to an antenna port 2. For each antenna port, the base station can transmit DMRS in one or more symbols. For example, the base station can transmit first DMRS in the subcarriers 0, 2, 4, 6, 8, and 10 and transmit second DMRS in the subcarriers 1, 3, 5, 7, 9, and 11 in a symbol 2 to a UE. The base station can also transmit first data corresponding to the first antenna port in all other symbols in the subcarriers 0, 2, 4, 6, 8, and 10 and transmit second data corresponding to the second antenna port in all other symbols in the subcarriers 1, 3, 5, 7, 9, and 11 to the UE. Because the first DMRS occupies the same subcarriers as the first data, the UE can assume that they experience same channel conditions and use the first DMRS to demodulate the first data. In some aspects, the first and the second DMRS can occupy a symbol other than the symbol 2. For example, in a mapping type A, the first and the second DMRS can occupy the symbol 2, as shown in the resource table 302a, or a symbol 3. In a mapping type B, the first and the second DMRS can occupy a first symbol in the physical downlink shared channel (PDSCH). For example, the PDSCH may occupy symbols 8-11 instead of the entire two resource blocks. In such a case, the first and the second DMRS can occupy the symbol 8, instead of the symbol 2, and the first and the second data can occupy symbols 9-11.

In some aspects, the base station can also assign subcarriers to multiple antenna ports. For example, the resource table 302b shows that the subcarriers 0, 2, 4, 6, 8, and 10 are also assigned to an antenna port 1 and the subcarriers 1, 3, 5, 7, 9, and 11 are also assigned to an antenna port 3. The base station can transmit a third DMRS and third data via the antenna port 1 and a fourth DMRS and fourth data via the antenna port 3. Because resource elements of the antenna ports 0 and 2 overlap with those of the antenna ports 1 and 3, respectively, the base station can multiplex DMRS using OCC. For example, the base station can apply a first OCC to the first DMRS and a third OCC to the third DMRS. As shown in the resource tables 302a and 302b, the first OCC can be [+, +] and the third OCC can be [+, −], and thus they are orthogonal to each other. For example, the resource table 302b shows the third OCC in two resource elements in the subcarriers 0 and 2 and symbol 2. The UE can distinguish the first DMRS and the third DMRS by applying corresponding OCC. For example, the UE can apply the first OCC to signals received in the subcarriers 0, 2, 4, 6, 8, and 10 and in the symbol 2. The signals are a combination of the first and the third DMRS. By applying the first OCC, the third DMRS is cancelled out because of the orthogonality and the first DMRS remains. Similarly, the second DMRS and the fourth DMRS can be distinguished using a second OCC, e.g., [+, +], and a fourth OCC, e.g., [+, −]. In some aspects, the antenna ports 0 and 1 are in a CDM group 0 because they share resource elements and are distinguished by OCC. Similarly, the antenna ports 2 and 3 are in a CDM group 1.

Similarly, resource tables 304a, 304b, 306a, and 306b of the example 300 illustrate DMRS configuration in two resource blocks for DMRS configuration type 1 with 2 symbols. Unlike the resource tables 302a and 302b that show 1-symbol DMRS, resource table 304a-d have a 2 symbol DMRS, so that 8 antenna ports are supported. For example, the base station can assign the subcarriers 0, 2, 4, 6, 8, and 10 to antenna ports 0, 1, 4, and 5 and assign the subcarriers 1, 3, 5, 7, 9, and 11 to antenna ports 2, 3, 6, and 7. To distinguish DMRS transmitted on antenna ports that share common subcarriers, the base station can apply OCC to the DMRS. For example, the base station can transmit a first, a second, a third, and a fourth DMRS via the antenna ports 0, 1, 4, and 5 in symbols 2 and 3 as shown in the resource tables 304a, 304b, 306a, and 306b respectively. In some aspects, a first OCC for the first DMRS can be [+, +, +, +] as shown in the resource table 304a, a second OCC for the second DMRS can be [+, +, −, −] as shown in the resource table 304b, a third OCC for the third DMRS can be [+, −, +, −] as shown in the resource table 306a, and a fourth OCC for the fourth DMRS can be [+, −, −, +] as shown in the resource table 306b. For example, the second OCC in the source table 304b are represented by four signs, i.e., [+, +, −, −], in four resource elements located in the subcarriers 0 and 2 and symbols 2 and 3. Similarly, OCC for DMRS of antenna ports 2, 3, 6, and 7 can be [+++++, +], [+, +, −, −], [+, −, +, −], and [+, −, −, +] as shown in the resource tables 304a, 304b, 306a, and 306b respectively. Here, the OCC of the antenna ports 0, 1, 4, and 5 are the same as the OCC of the antenna ports 2, 3, 6, and 7 respectively.

In summary, the DMRS configuration of type 1 with 1 symbol supports 4 antenna ports and the DMRS configuration of type 1 with 2 symbols supports 8 antenna ports. In some aspects, the antenna ports discussed in FIG. 3 above are referred to as legacy antenna ports.

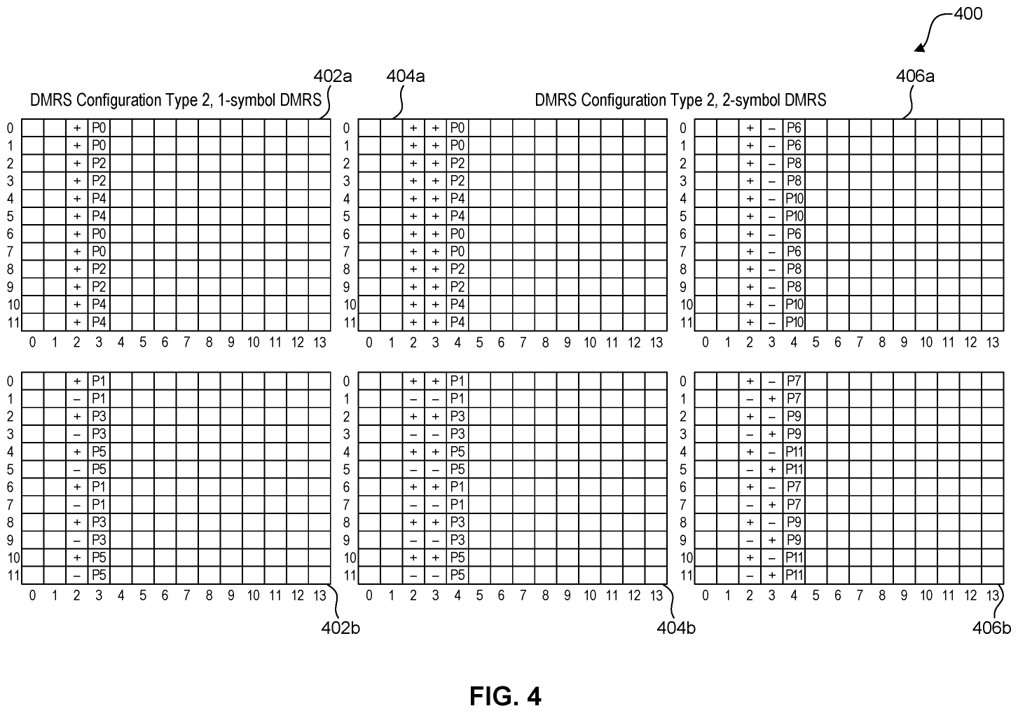

FIG. 4 illustrates an example 400 of a type 2 reference signal configuration. The example 400 is provided for the purpose of illustration only and does not limit the disclosed aspects. As a convenience and not a limitation, FIG. 4 may be described with regard to elements of FIGS. 1, 2, and 11. The example 400 may represent the operation of electronic devices (for example, the UEs 102, 106, and the base station 104 of FIG. 1) implementing the reference signal configuration procedure. The example 400 may also be performed by the electronic device 200 of FIG. 2, controlled or implemented by processor 210, and/or computer system 1100 of FIG. 11. But the example 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

In some aspects, the example 400 includes resource tables 402a and 402b that illustrate DMRS configuration in two resource blocks for DMRS configuration type 2 with 1 symbol. In some aspects, a base station, such as the base station 104, can assign the subcarriers to multiple antenna ports. For example, the resource tables 402a and 402b show that subcarriers 0, 1, 6, and 7 are assigned to antenna ports 0 and 1 that are in a CDM group 0, subcarriers 2, 3, 8, and 9 are assigned to antenna ports 2 and 3 that are in a CDM group 1, and subcarriers 4, 5, 10, and 11 are assigned to antenna ports 4 and 5 that are in a CDM group 2. Similar to FIG. 3, DMRS transmitted via antenna ports in the same CDM group are distinguished by their respective OCC. For example, the antenna ports 0, 2, and 4 are associated with a first OCC [+, +]. The antenna ports 1, 3, and 5 are associated with a second OCC [+, −].

Similarly, resource tables 404a, 404b, 406a, and 406b of the example 400 illustrate DMRS configuration in two resource blocks for DMRS configuration type 2 with 2 symbols. In some aspects, a base station, such as the base station 104, can assign the subcarriers to multiple antenna ports. For example, subcarriers 0, 1, 6, and 7 are assigned to antenna ports 0, 1, 6, and 7 that are in a CDM group 0, subcarriers 2, 3, 8, and 9 are assigned to antenna ports 2, 3, 8, and 9 that are in a CDM group 1, and subcarriers 4, 5, 10, and 11 are assigned to antenna ports 4, 5, 10, and 11 that are in a CDM group 2. Similar to FIG. 3, DMRS transmitted via antenna ports in the same CDM group are distinguished by their respective OCC. For example, the antenna ports 0, 2, and 4 are associated with a first OCC [+, +, +, +] as shown in the resource table 404a. The antenna ports 1, 3, and 5 are associated with a second OCC [+, +, −, −] as shown in the resource table 404b. The antenna ports 6, 8, and 10 are associated with a third OCC [+, −, +, −] as shown in the resource table 406a. The antenna ports 7, 9, and 11 are associated with a fourth OCC [+, −, −, +] as shown in the resource table 406b.

In summary, the DMRS configuration of type 2 with 1 symbol supports 6 antenna ports and the DMRS configuration of type 2 with 2 symbols supports 12 antenna ports. In some aspects, the antenna ports discussed in FIG. 4 above are referred to as legacy antenna ports.

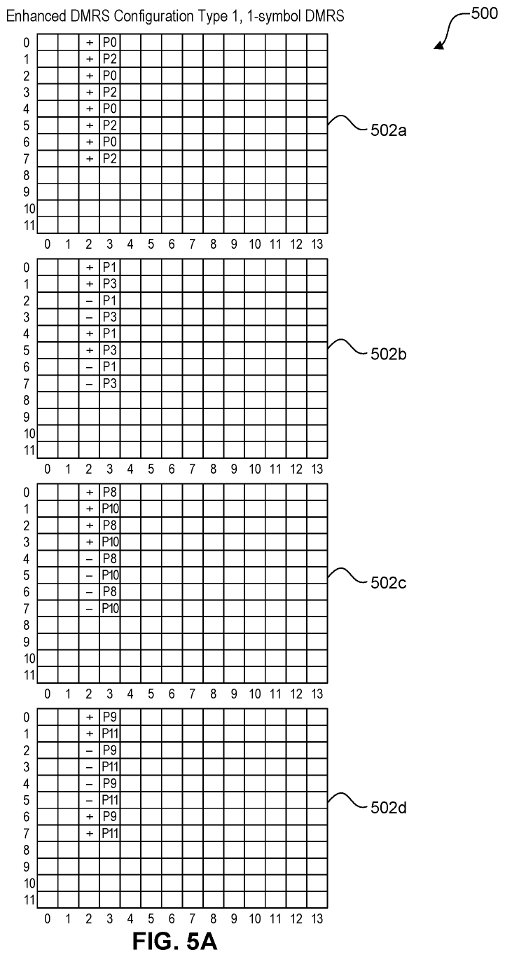

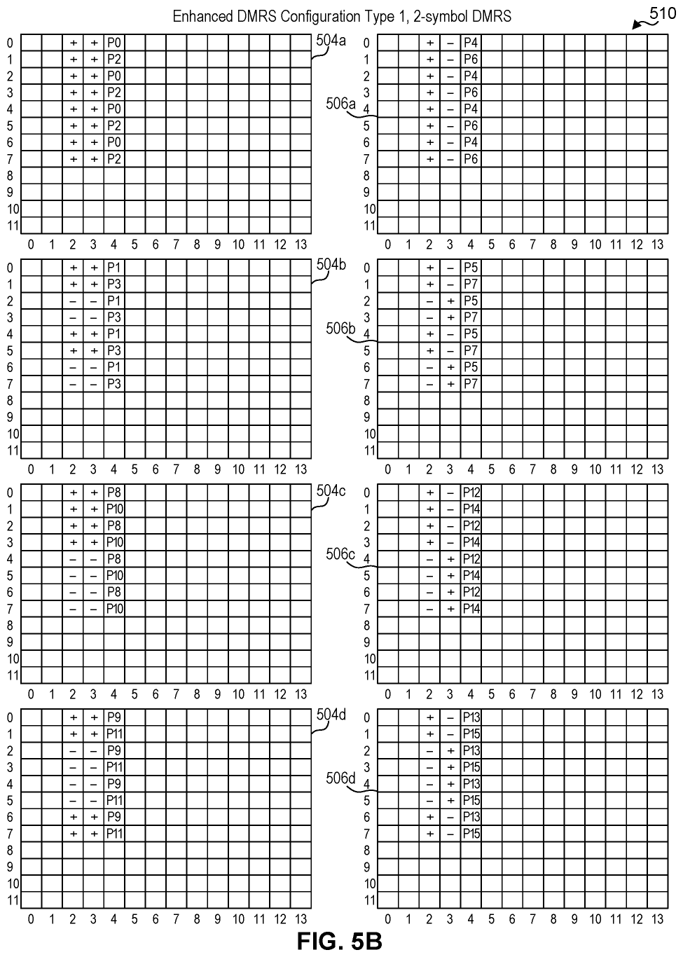

FIGS. 5A and 5B respectively illustrate examples 500 and 510 of an enhanced type 1 reference signal configuration, according to aspects of the disclosure. As a convenience and not a limitation, FIGS. 5A and 5B may be described with regard to elements of FIGS. 1, 2, and 11. The examples 500 and 510 may represent the operation of electronic devices (for example, the UEs 102, 106, and the base station 104 of FIG. 1) implementing the reference signal configuration procedure. The example 500 may also be performed by the electronic device 200 of FIG. 2, controlled or implemented by processor 210, and/or computer system 1100 of FIG. 11. But the examples 500 and 510 are not limited to the specific aspects depicted in those figures and other systems may be used to perform the method, as will be understood by those skilled in the art. It is to be appreciated that not all operations may be needed, and the operations may not be performed in the same order as shown in FIGS. 5A and 5B.

In some aspects, as shown in FIG. 5A, the example 500 includes resource tables 502a, 502b, 502c, and 502d that illustrate DMRS configuration in two resource blocks for enhanced DMRS configuration type 1 with 1 symbol. In some aspects, a base station, such as the base station 104, can assign the subcarriers to multiple antenna ports. For example, subcarriers 0, 2, 4, and 6 are assigned to antenna ports 0, 1, 8, and 9 that are in a CDM group 0, subcarriers 1, 3, 5, and 7 are assigned to antenna ports 2, 3, 10, and 11 that are in a CDM group 1. DMRS transmitted via antenna ports in the same CDM group are distinguished by their respective OCC. For example, the antenna ports 0 and 2 are associated with a first OCC [+, +, +, +] as shown in the resource table 502a. The antenna ports 1 and 3 are associated with a second OCC [+, −, +, −] as shown in the resource table 502b. The antenna ports 8 and 10 are associated with a third OCC [+, +, −, −] as shown in the resource table 502c. The antenna ports 9 and 11 are associated with a fourth OCC [+, −, −, +] as shown in the resource table 502d. In some aspects, the antenna ports 0, 1, 2, and 3 are referred to as legacy antenna ports and the antennas ports 8, 9, 10, and 11 are referred to as new antenna ports. The legacy antenna ports are supported in LTE systems and the UE can detect and extract DMRS transmitted via legacy antenna ports using legacy OCC, such as the OCC discussed in FIGS. 3 and 4. The new antenna ports are supported in 5G NR systems and the UE needs to generate new OCC to detect and extract DMRS transmitted via new antenna ports. For example, as shown in resource tables 302a and 302b of FIG. 3 and discussed above, the DMRS configuration of type 1 with 1 symbol requires OCC of a length 2, e.g., the first OCC [+, +] and the second OCC [+, −] of FIG. 3, which can be referred to as legacy OCC. Here, the legacy antenna ports 0, 1, 2, and 3 are associated with the first OCC [+, +, +, +] and the second OCC [+, −, +, −], as discussed above. Thus, the first OCC and the second OCC of FIG. 5A can be seen as the first OCC and the second OCC of FIG. 3 that repeat two times, respectively. In such as case, the UE can apply the first and the second OCC of FIG. 3, i.e., [+, +] and [+, −], to detect and extract the DMRS that are coded with the first and the second OCC of FIG. 5A, i.e., [+, +, +, +] and [+, −, +, −]. Likewise, for the new antenna ports, the UE needs to determine the new OCC to detect and extract the DMRS transmitted via the new antenna ports.

In some aspects, the UE may detect and extract the DMRS via the new antenna ports to estimate interference caused by the new antenna ports. Specifically, the new antenna ports may share resource elements with legacy antenna ports. The base station may assign legacy antenna ports to the UE, but assign new antenna ports to a second UE. For example, the base station may assign the legacy antenna ports 0 and 1 to the UE and assigns the new antenna ports 8 and 9 to the second UE. Because the legacy antenna ports 0 and 1 and the new antenna ports 8 and 9 share same resource elements, the UE can estimate interference caused by data transmitted via the new antenna ports 8 and 9. To do that, the UE needs to detect and extract the DMRS transmitted via the new antenna ports 8 and 9 and thus needs to determine the third OCC [+, +, −, −] and the four OCC [+, −, −, +]. However, the UE may or may not be capable of determining the third and the four OCC and extracting the DMRS. In some aspects, the UE may be associated with different capability values. For example, the UE may be associated with a UE capability 0, which indicates that the UE is not able to determine the third and the four OCC and extract the DMRS when the base station assigns the legacy antenna ports 0 and 1 to the UE. For another example the UE may be associated with a UE capability 1 or 2, which indicates that the UE is able to determine the third and the four OCC and extract the DMRS when the base station assigns the legacy antenna ports 0 and 1 to the UE.

Similarly, in FIG. 5B, resource tables 504a, 504b, 504c, 504d, 506a, 506b, 506c, and 506d of the example 510 each illustrates DMRS configuration in two resource blocks for enhanced DMRS configuration type 1 with 2 symbols. In some aspects, a base station, such as the base station 104, can assign the subcarriers to multiple antenna ports. For example, subcarriers 0, 2, 4, and 6 are assigned to legacy antenna ports 0, 1, 4, and 5 and new antenna ports 8, 9, 12, and 13 that are in a CDM group 0; subcarriers 1, 3, 5, and 7 are assigned to legacy antenna ports 2, 3, 6, and 7 and new antenna ports 10, 11, 14, and 15 that are in a CDM group 1. DMRS transmitted via antenna ports in the same CDM group are distinguished by their respective OCC. For example, the legacy antenna ports 0 and 2 are associated with OCC [+, +, +, +, +, +, +, +]. The legacy antenna ports 1 and 3 are associated with OCC [+, +, −, −, +, +, −, −]. The new antenna ports 8 and 10 are associated with OCC [+, +, +, +, −, −, −, −]. The new antenna ports 9 and 11 are associated with OCC [+, +, −, −, −, −, +, +]. The legacy antenna ports 4 and 6 are associated with OCC [+, −, +, −, +, −, +, −]. The legacy antenna ports 5 and 7 are associated with OCC [+, −, −, +, +, −, −, +]. The new antenna ports 12 and 14 are associated with OCC [+, −, +, −, −, +, −, +]. The new antenna ports 13 and 15 are associated with OCC [+, −, −, +, −, +, +, −]. Similar to FIG. 5A and discussion above, the OCC of the legacy antenna ports are in forms of repeating legacy OCC and the UE can use legacy OCC to detect and extract DMRS transmitted via the legacy antenna ports described here in FIG. 5B. However, the UE needs to determine and generate the OCC of the new antenna ports to detect and extract the DMRS transmitted via the new antenna ports.

In summary, the enhanced DMRS configuration of type 1 with 1 symbol supports 8 antenna ports and the enhanced DMRS configuration of type 1 with 2 symbols supports 16 antenna ports.

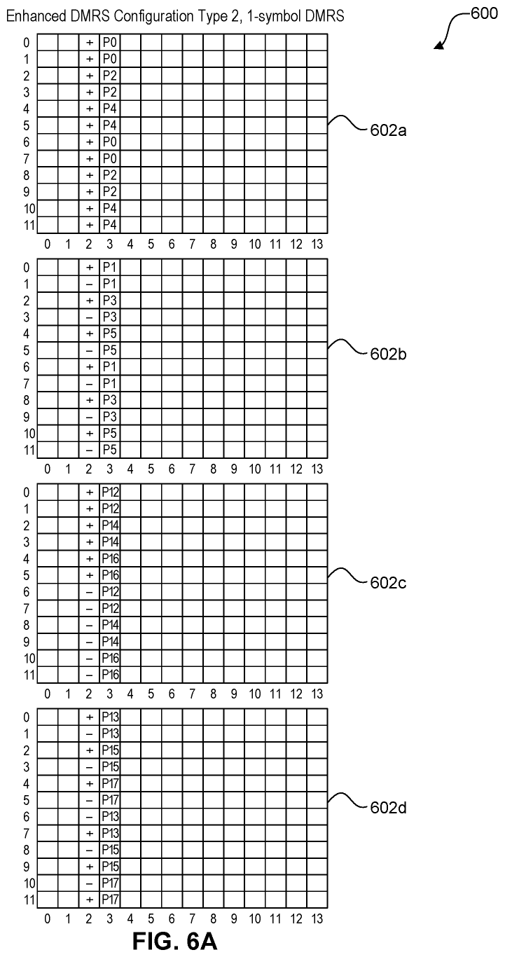

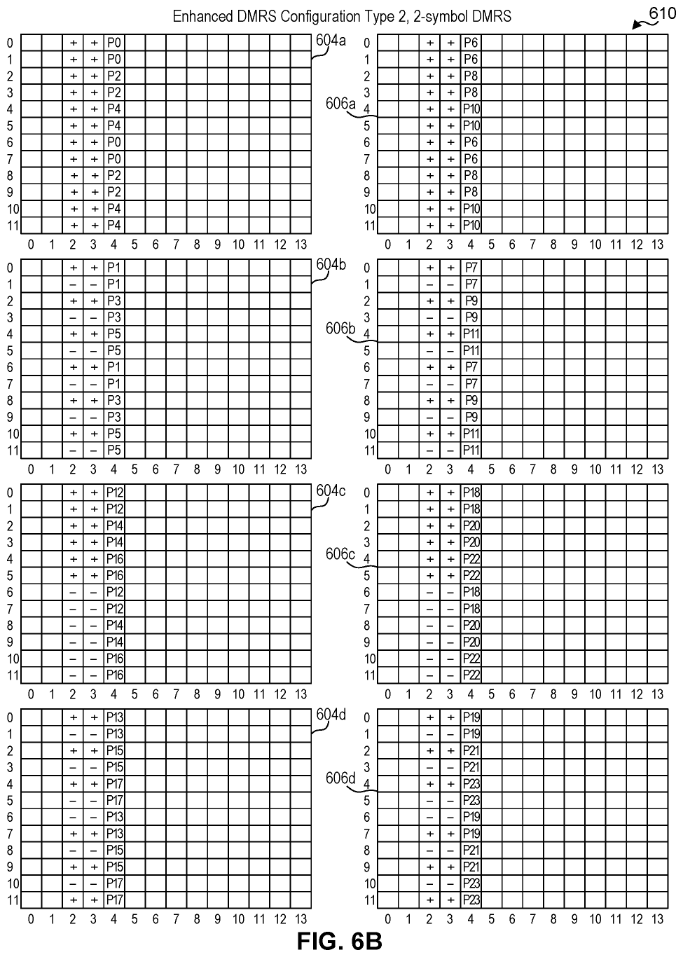

FIGS. 6A and 6B respectively illustrate examples 600 and 610 of an enhanced type 2 reference signal configuration, according to aspects of the disclosure. As a convenience and not a limitation, FIGS. 6A and 6B may be described with regard to elements of FIGS. 1, 2, and 11. The example 600 may represent the operation of electronic devices (for example, the UEs 102, 106, and the base station 104 of FIG. 1) implementing the reference signal configuration procedure. The examples 600 and 610 may also be performed by the electronic device 200 of FIG. 2, controlled or implemented by processor 210, and/or computer system 1100 of FIG. 11. But the examples 600 and 610 are not limited to the specific aspects depicted in those figures and other systems may be used to perform the method, as will be understood by those skilled in the art. It is to be appreciated that not all operations may be needed, and the operations may not be performed in the same order as shown in FIGS. 6A and 6B.

In some aspects, as shown in FIG. 6A, the example 600 includes resource tables 602a, 602b, 602c, and 602d that illustrate DMRS configuration in two resource blocks for enhanced DMRS configuration type 2 with 1 symbol. In some aspects, a base station, such as the base station 104, can assign the subcarriers to multiple antenna ports. For example, subcarriers 0, 1, 6, and 7 are assigned to legacy antenna ports 0 and 1 and new antenna ports 12 and 13 that are in a CDM group 0, subcarriers 2, 3, 8, and 9 are assigned to legacy antenna ports 2 and 3 and new antenna ports 14 and 15 that are in a CDM group 1, subcarriers 4, 5, 10, and 11 are assigned to legacy antenna ports 4 and 5 and new antenna ports 16 and 17 that are in a CDM group 2. DMRS transmitted via antenna ports in the same CDM group are distinguished by their respective OCC. The detailed OCC assignments are shown in FIG. 6A. Similar to the discussion above in FIG. 5A, the UE can use OCC of LTE systems to detect and extract DMRS transmitted via the legacy antenna ports described here. However, the UE needs to determine and generate new OCC to detect and extract DMRS transmitted via the new antenna ports described here.

Similarly, resource tables 604a, 604b, 604c, 604d, 606a, 606b, 606c, and 606d of the example 610 illustrate DMRS configuration in two resource blocks for enhanced DMRS configuration type 2 with 2 symbols. In some aspects, a base station, such as the base station 104, can assign the subcarriers to multiple antenna ports. For example, subcarriers 0, 1, 6, and 7 are assigned to legacy antenna ports 0, 1, 6, and 7 and new antenna ports 12, 13, 18, and 19 that are in a CDM group 0; subcarriers 2, 3, 8, and 9 are assigned to legacy antenna ports 2, 3, 8, and 9 and new antenna ports 14, 15, 20, and 21 that are in a CDM group 1; and subcarriers 4, 5, 10 and 11 are assigned to legacy antenna ports 4, 5, 10, and 11 and new antenna ports 16, 17, 22, and 23 that are in a CDM group 2. DMRS transmitted via antenna ports in the same CDM group are distinguished by their respective OCC. The detailed OCC assignments are shown in FIG. 6A.

In summary, the enhanced DMRS configuration of type 2 with 1 symbol supports 12 antenna ports and the enhanced DMRS configuration of type 1 with 2 symbols supports 24 antenna ports.

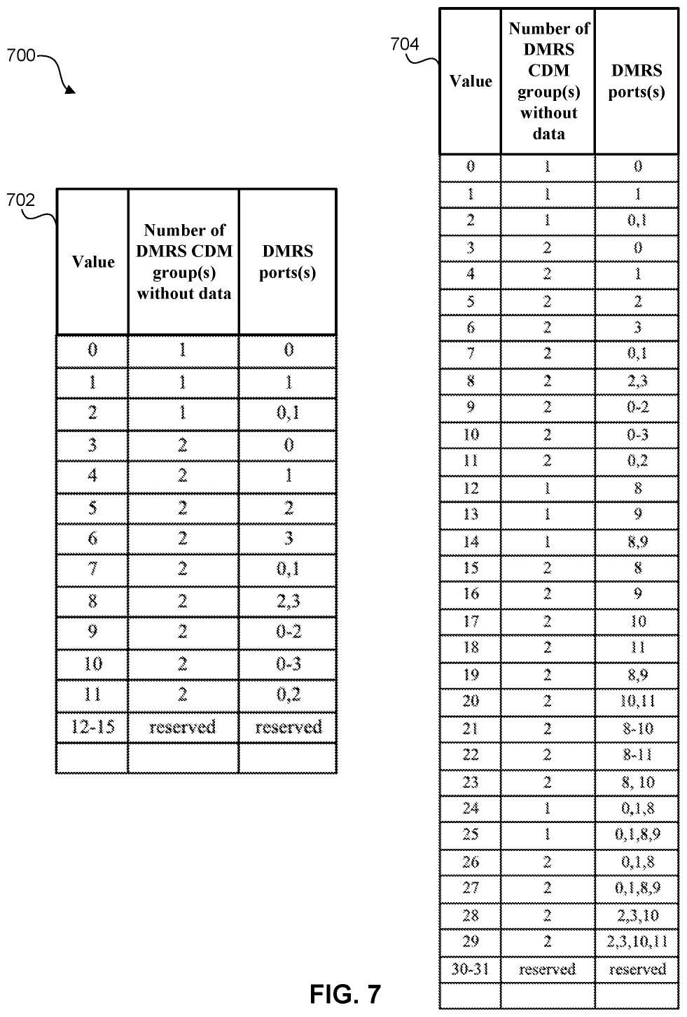

FIG. 7 illustrates example 700 of a legacy configuration table and a new configuration table. The example 700 is provided for the purpose of illustration only and does not limit the disclosed aspects. As a convenience and not a limitation, FIG. 7 may be described with regard to elements of FIGS. 1, 2, and 11. The example 700 may represent the operation of electronic devices (for example, the UEs 102, 106, and the base station 104 of FIG. 1) implementing the reference signal configuration procedure. The example 700 may also be performed by the electronic device 200 of FIG. 2, controlled or implemented by processor 210, and/or computer system 1100 of FIG. 11. But the example 700 is not limited to the specific aspects depicted in those figures and other systems may be used to perform the method, as will be understood by those skilled in the art. It is to be appreciated that not all operations may be needed, and the operations may not be performed in the same order as shown in FIG. 7.

In some aspects, the example 700 includes a legacy configuration table 702. In some aspects, a base station, such as the base station 104 of FIG. 1, can transmit a configuration message to a UE, wherein the configuration message includes the legacy configuration table 702. In other aspects, the legacy configuration table 702 is preconfigured and stored in the UE. The legacy configuration table 702 includes a plurality of rows and each row represents an antenna port configuration. For example, a first row having value 0 indicates that an antenna port 0 is configured. In some aspects, the configuration message can indicate the first row to configure the UE with the antenna port 0. For example, the configuration message can indicate the row value 0. For another example, the configuration message can indicate a row value 10, which represents antenna ports 0-3. In such a case, the UE is configured with the antenna ports 0-3.

In some aspects, the example 700 also includes a new configuration table 704. Each row of the table 704 represents an antenna port configuration. In some aspects, the new configuration table 704 can indicate new antenna ports. For example, a row with a row value 21 indicates antenna ports 8-10 which are new antenna ports in the enhanced DMRS configuration type 1 with 1 symbol. The base station can use the new configuration table 704 to configure the UE with legacy antenna ports, new antenna ports, or a combination thereof.

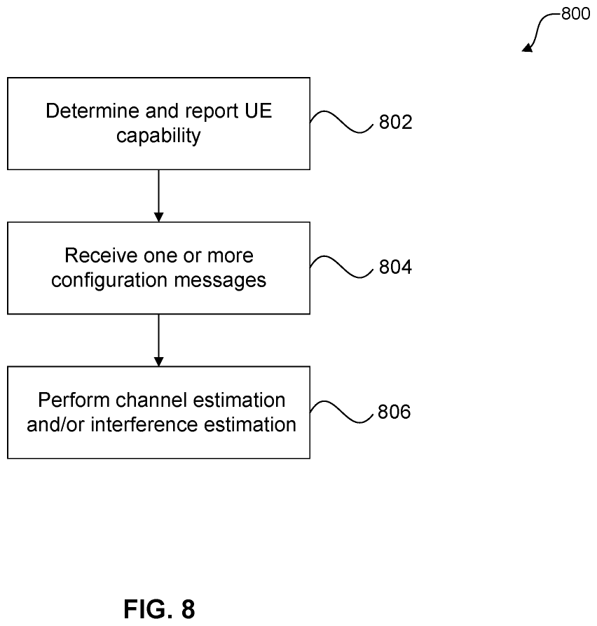

FIG. 8 illustrates an example method 800 of the reference signal configuration procedure at a UE, according to aspects of the disclosure. The example method 800 is provided for the purpose of illustration only and does not limit the disclosed aspects. As a convenience and not a limitation, FIG. 8 may be described with regard to elements of FIGS. 1, 2, and 11. The example method 800 may represent the operation of electronic devices (for example, the UEs 102, 106, and the base station 104 of FIG. 1) implementing the reference signal configuration procedure. The example method 800 may also be performed by the electronic device 200 of FIG. 2, controlled or implemented by processor 210, and/or computer system 1100 of FIG. 11. But the example method 800 is not limited to the specific aspects depicted in those figures and other systems may be used to perform the method, as will be understood by those skilled in the art. It is to be appreciated that not all operations may be needed, and the operations may not be performed in the same order as shown in FIG. 8.

At 802, a UE, such as the UE 102, determines and reports its UE capability. In some aspects, the UE capability can be capability 0, capability 1, capability 2, or other capability. The capability 0 indicates that the UE is not able to detect and extract DMRS transmitted via new antenna ports of a CDM group when the UE is configured with legacy antenna ports of the CDM group. The capability 1 indicates that the UE is able to detect and extract DMRS transmitted via new antenna ports of a CDM group when the UE is configured with legacy antenna ports of the CDM group. The capability 2 indicates that the UE is able to detect and extract DMRS transmitted via new antenna ports and/or legacy antenna ports of a CDM group when the UE is configured with legacy antenna ports and/or new antenna ports of the CDM group. As such, capability 2 has no conditions required to detect legacy or new antenna ports, unlike capability 1. In some aspects, the UE can determine the UE capability based on the hardware components, such as transceiver circuitry or one or more processors of the UE. The UE can also determine the UE capability based on a user preference or a network configuration. After determining the UE capability, the UE can report it to a base station, such as the base station 104 of FIG. 1.

In some aspects, the UE capability can further indicate whether the UE is a legacy UE or a new UE. For example, a legacy UE can operate based on legacy standards, such as 3GPP standards Rel-15 and/or Rel-16. A new UE can operate based on new standards, such as 3GPP standards Rel-18 or later releases. In some aspects, the legacy UE can correspond to capability 0 and the new UE can correspond to capability 1, capability 2, or other capabilities.

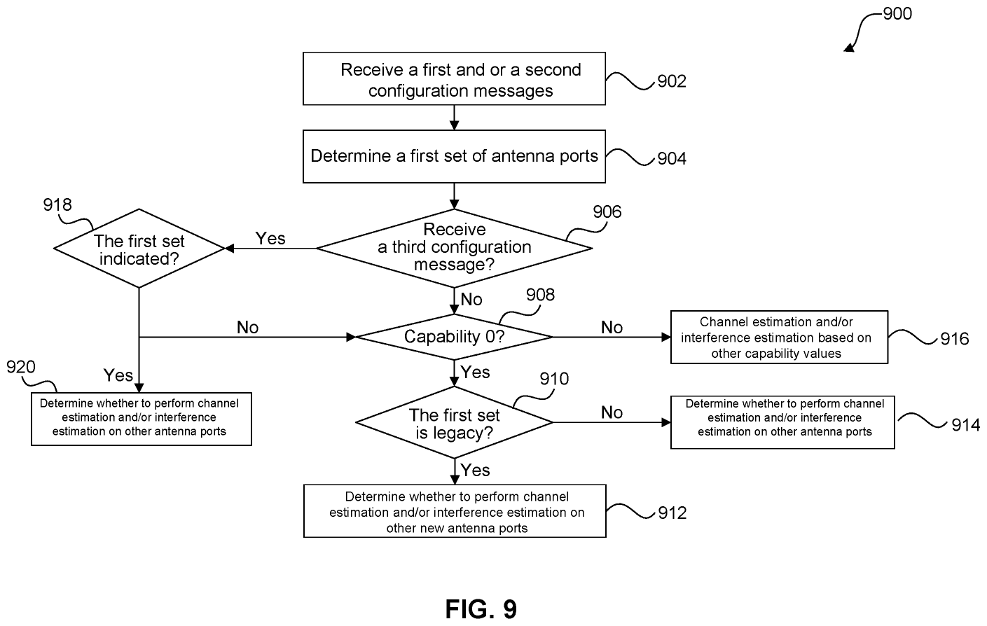

At 804, the UE receives one or more configuration messages. In some aspects, the UE can receive a first and a second configuration messages to indicate one or more antenna ports. In some aspects, the base station assigns the one or more antenna ports to the UE. For example, the first configuration message can include the legacy configuration table 702 or the new configuration table 704. The second configuration message can further indicate a row in the legacy configuration table 702 or the new configuration table 704. For another example, the UE may be preconfigured with the legacy configuration table 702 or the new configuration table 704. In such a case, the first configuration message can indicate a row in the legacy configuration table 702 or the new configuration table 704 without requiring the second configuration message. In some aspects, the UE can receive a third configuration message that can overwrite the UE capability reported in 802. For example, the UE may report the capability 1, but the third configuration message may configure the UE to operate as the capability 0. More details of the third configuration message are discussed further below in FIG. 9.

At 806, the UE performs channel estimation and/or interference estimation based on the one or more configuration messages. In some aspects, the UE can perform channel estimation on antenna ports that are assigned to the UE, such as the one or more antenna ports assigned to the UE by the one or more configuration messages received in 804. Furthermore, the UE can determine whether to perform channel estimation and/or interference estimation on antenna ports that are not assigned to the UE based on the one or more configuration messages and/or the UE capability. More details are discussed further below in FIG. 9. In some aspects, the antenna ports assigned to the UE and the antenna ports not assigned to the UE can be DMRS antenna ports of the mapping type A or the mapping type B.

FIG. 9 illustrates an example method 900 of performing channel estimation, according to aspects of the disclosure. The example method 900 provides detailed descriptions of steps 804 and 806 of FIG. 8. The example method 900 is provided for the purpose of illustration only and does not limit the disclosed aspects. As a convenience and not a limitation, FIG. 9 may be described with regard to elements of FIGS. 1, 2, and 11. The example method 900 may represent the operation of electronic devices (for example, the UEs 102, 106, and the base station 104 of FIG. 1) implementing the reference signal configuration procedure. The example method 900 may also be performed by the electronic device 200 of FIG. 2, controlled or implemented by processor 210, and/or computer system 1100 of FIG. 11. But the example method 900 is not limited to the specific aspects depicted in those figures and other systems may be used to perform the method, as will be understood by those skilled in the art. It is to be appreciated that not all operations may be needed, and the operations may not be performed in the same order as shown in FIG. 9.

At 902, a UE, such as the UE 102, receives a first and/or a second configuration message from a base station, as described in 804 of FIG. 8. In some aspects, the first configuration message can indicate one or more antenna ports. For example, the second configuration message can include an antenna port configuration table, such as the legacy configuration table 702 or the new configuration table 704 of FIG. 7. The first configuration message can indicate a row in the antenna port configuration table that includes the one or more antenna ports. In some aspects, the antenna port configuration table can be preconfigured and stored in the UE. In such a case, the second configuration message is not required.

At 904, the UE determines a first set of antenna ports. In some aspects, the first set of antenna ports are the one or more antenna ports indicated by the first configuration message. Thus, the base station assigns the first set of antenna ports to the UE via the first configuration message. In some aspects, the first set of antenna ports are DMRS antenna ports. The first set of antenna ports can be the mapping type A or the mapping type B.

At 906, the UE determines whether a third configuration message is received from the base station. The third configuration message can indicate to the UE whether to perform channel estimation and interference estimation on antenna ports that are in a same CDM group as the first set of antenna ports but are not assigned to the UE. The UE may determine that the third configuration message is not received and the control moves to 908.

At 908, the UE determines whether the UE capability is 0. In some aspects, the UE determines the UE capability and reports it to the base station, as described in 802 of FIG. 8. The UE can store the UE capability in memory of the UE, such as memory 250. In some aspects, UE capability can be capability 0, capability 1, capability 2, and other capability. The capability 0 is also referred to as a default capability, which indicates that the UE is not able to, or configured not to, perform channel estimation and interference estimation on antenna ports that are in a same CDM group as the first set of antenna ports but are not assigned to the UE. In some aspects, the UE can determine the UE capability based on the first configuration message. For example, the first configuration message may include a legacy configuration table, such as the legacy configuration table 702 of FIG. 7. In such a case, the UE can assume that the UE capability is 0. For another example, the first configuration may include a new configuration table, such as the new configuration table 704 of FIG. 7. In such a case, the UE can assume that the UE capability is 1 or 2. If the UE determines that the UE capability is 0, the control moves to 910.

At 910, the UE can determine whether the first set of antenna ports are legacy antenna ports. The UE can determine based on antenna ports numbers. For example, as discussed in FIG. 5A, for the enhanced DMRS configuration type 1 with 1 symbol, the antenna ports 0, 1, 2, and 3 are legacy antenna ports and the antenna ports 8, 9, 10, and 11 are new antenna ports. It is worth noting that an antenna port number X in this application can also be interpreted as an antenna port number 1000+X. For example, the legacy antenna ports 0, 1, 2, and 3 can also be interpreted as legacy antenna ports 1000, 1001, 1002, and 1003 and the new antenna port numbers 8, 9, 10, and 11 can also be interpreted as new antenna ports 1008, 1009, 1010, and 1011. If the UE determines that the first set of antenna ports are legacy antenna ports, the control moves to 912.

At 912, the UE determines whether to perform channel estimation and interference estimation on antenna ports that are not assigned in a CDM group. For example, the UE may be in the enhanced DMRS configuration type 1 with 1 symbol, as discussed in FIG. 5A. The first set of antenna ports may be the legacy antenna ports 0 and 1, which are in a CDM group 0. Accordingly, the antenna ports that are not assigned to the UE in the CDM group 0 are the new antenna ports 8 and 9. In some aspects, the UE can assume that the base station assigns antenna ports based on the UE capability reported by the UE. For example, the base station, such as the base station 104, receives the UE capability 0 reported by the UE, as discussed in the step 802 of FIG. 8, and thus does not assign the new antenna ports 8 and 9 to other UEs. In such a case, the UE can refrain from performing channel estimation or interference estimation on the new antenna ports 8 and 9. In some aspects, the UE having the UE capability 0 may not be capable of determining new OCC that is required to detect and extract DMRS transmitted via the new antenna ports 8 and 9. Thus, without the DMRS, the UE is not able to perform channel estimation or interference estimation on the new antenna ports 8 and 9. In other aspects, the UE having the UE capability 0 may be capable of determining the new OCC, but is configured not to perform channel estimation or interference estimation on the new antenna ports 8 and 9 to save energy and computational resources or to achieve other purposes. In some aspects, the UE can be configured with the UE capability 0 by a user of the UE or the base station.

Still referring to 912, in some aspects, the UE may be in the DMRS configuration type 1 with 2 symbols as discussed in FIG. 3. The first set of antenna ports may be the legacy ports 0 and 1, which are in a CDM group 0. Accordingly, the antenna ports that are not assigned to the UE in the CDM group 0 are the legacy antenna ports 4 and 5. In such a case, the UE can perform channel estimation and interference estimation on the legacy antenna ports 4 and 5.

Referring back to 910, if the UE determines that the first set of antenna ports are not legacy antenna ports, the control moves to 914. For example, the first set of antenna ports can be new antenna ports or a combination of legacy and new antenna ports.

At 914, the UE can determine whether to perform channel estimation and/or interference estimation on other antenna ports. In some aspects, the UE can perform the channel estimation and/or the interference estimation on the other antenna ports (not the first set of antenna ports) that are not assigned to the UE in a CDM group if they are legacy antenna ports and refrain from doing so if they are new antenna ports. In some aspects, the UE can assume that the base station overwrites the UE capability 0 reported to the base station by assigning the new antenna ports to the UE. In such a case, the UE can determine whether to perform the channel estimation and/or the interference estimation based on other UE capability, such as the UE capability 1 or the UE capability 2, as further discussed in 916.

Referring back to 908, if the UE determines that the UE capability is not 0, the control moves to 916.

At 916, the UE can determine whether to perform the channel estimation and/or the interference estimation on antenna ports that are not assigned to the UE in a CDM group based on the UE capability reported. If the UE reported the UE capability 1 and if the first set of antenna ports are legacy antenna ports, the UE can perform the channel estimation and/or the interference estimation on antenna ports that are not assigned to the UE in the CDM group. For example, the UE may be in the enhanced DMRS configuration type 1 with 1 symbol, as discussed in FIG. 5A. The first set of antenna ports may be the legacy antenna ports 0 and 1, which are in a CDM group 0. Accordingly, the antenna ports that are not assigned to the UE in the CDM group 0 are the new antenna ports 8 and 9. In such a case, the UE can perform the channel estimation and/or interference estimation on the new antenna ports 8 and 9. Likewise, if the UE reported the UE capability 1 and the first set of antenna ports are new antenna ports, the UE can refrain from performing the channel estimation and/or the interference estimation on antenna ports that are not assigned to the UE in the CDM group.

In some aspects, the UE may report the UE capability 2. If the first set of antenna ports are legacy antenna ports, the UE can perform the channel estimation and/or interference estimation on antenna ports not assigned to the UE. For example, the UE may be in the enhanced DMRS configuration type 2 with 2 symbols, as discussed in FIG. 6B. The first set of antenna ports may be the legacy antenna ports 4 and 5, which are in a CDM group 2. Thus, in the CDM group 2, the legacy antenna ports 10 and 11 and the new antenna ports 16, 17, 22, and 23 are not assigned to the UE. In other words, the unassigned antenna ports are a combination of legacy antenna ports and new antenna ports. In such a case, the UE can perform the channel estimation and/or the interference estimation on the legacy antenna ports 10 and 11 and the new antenna ports 16, 17, 22, and 23. In some aspects, the UE can assume that the base station assigns the legacy antenna ports 10 and 11 and the new antenna ports 16, 17, 22, and 23 to other UEs based on the UE capability 2 reported to the base station.

In some aspects, the first set of antenna ports are a combination of legacy antenna ports and new antenna ports. For example, the UE may be in the enhanced DMRS configuration type 2 with 2 symbols, as discussed in FIG. 6B. The first set of antenna ports may be the legacy antenna ports 4 and 5 and the new antenna ports 16 and 17, which are in a CDM group 2. Thus, in the CDM group 2, the legacy antenna ports 10 and 11 and the new antenna ports 22 and 23 are not assigned to the UE. In other words, the UE is assigned with a combination of legacy antenna ports and new antenna ports. In such a case, the UE can assume that the base station assigns the legacy antenna ports 10 and 11 to be vacant and assigns the new antenna ports 22 and 23 to other UEs. Therefore, the UE can perform the channel estimation and/or the interference estimation on the new antenna ports 22 and 23, but refrain from performing the channel estimation and/or the interference estimation on the legacy antenna ports 10 and 11. Likewise, the UE can alternatively assume that the base station assigns the legacy antenna ports 10 and 11 and the new antenna ports 22 and 23 to other UEs. In such a case, the UE can perform the channel estimation and/or the interference estimation on both the legacy antenna ports 10 and 11 and the new antenna ports 22 and 23.

Referring back to 906, if the UE receives the third configuration message, the control moves to 918.

At 918, the UE determines whether the first set of antenna ports is indicated in the third configuration message. In some aspects, the third configuration message can indicate row values in a configuration table, such as the legacy configuration table 702 or the new configuration table 704 of FIG. 7. For example, the third configuration message can include row values 2-5, which corresponds to 4 rows in the legacy configuration table 702. The first set of antenna ports may the antenna ports 0 and 1. Thus, the first set of antenna ports is indicated by the row value 2 of the third configuration message. In such a case, the control moves to 920.

At 920, the UE determines whether to perform the channel estimation and/or the interference estimation on other antenna ports that are not assigned to the UE. For example, the UE may be in the enhanced DMRS configuration type 1 with 1 symbol, as discussed in FIG. 5A. The antenna ports 0 and 1 are legacy antenna ports in a CDM group 0. Thus, the antenna ports that are not assigned to the UE in the CDM group 0 are new antenna ports 8 and 9. The UE can refrain from performing the channel estimation and/or the interference estimation on the new antenna ports 8 and 9 based on the third configuration message. For example, the UE may report the UE capability 1 or the UE capability 2 in the step 802 of FIG. 8. However, based on the third configuration message, the UE still refrains from performing the channel estimation and/or the interference estimation on the new antenna ports 8 and 9 regardless of the UE capability reported. In other words, if the first set of antenna ports is indicated by the third configuration message, the UE can assume that unassigned new antenna ports in the same CDM group as the first set of antenna ports are not assigned to other UEs and thus refrain from performing the channel estimation and/or the interference estimation on these unassigned new antenna ports.

In some aspects, the UE can assume that any unassigned antenna ports, either legacy or new, in the same CDM group as the first set of antenna ports are not assigned to other UEs and thus refrain from performing the channel estimation and/or the interference estimation on these unassigned antenna ports. For example, the UE may be in the enhanced DMRS configuration type 2 with 2 symbols, as discussed in FIG. 6B. The antenna ports 0 and 1 are legacy antenna ports in a CDM group 0. Thus, the antenna ports that are not assigned to the UE in the CDM group 0 are legacy antenna ports 6 and 7 and new antenna ports 12, 13, 18, and 19. Based on the third configuration message, the UE can assume that the legacy antenna ports 6 and 7 and the new antenna ports 12, 13, 18, and 19 are not assigned to other UEs, regardless of the UE capability reported.

Referring back to 918, if the UE determines that the first set of antenna ports is not indicated by the third configuration message, the control moves to 908, where the UE determines whether to perform the channel estimation and/or the interference estimation on unassigned antenna ports based on the UE capability.

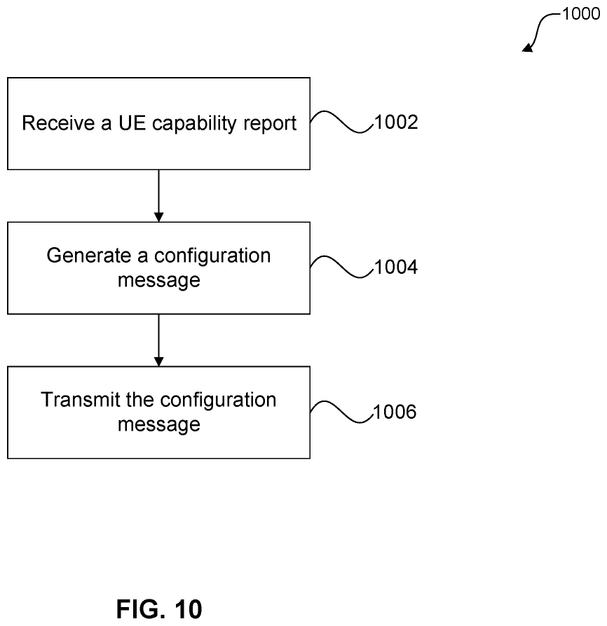

FIG. 10 illustrates an example method 1000 of the reference signal configuration procedure at a base station, according to aspects of the disclosure. The example method 1000 is provided for the purpose of illustration only and does not limit the disclosed aspects. As a convenience and not a limitation, FIG. 10 may be described with regard to elements of FIGS. 1, 2, and 11. The example method 1000 may represent the operation of electronic devices (for example, the UEs 102, 106, and the base station 104 of FIG. 1) implementing the reference signal configuration procedure. The example method 1000 may also be performed by the electronic device 200 of FIG. 2, controlled or implemented by processor 210, and/or computer system 1100 of FIG. 11. But the example method 1000 is not limited to the specific aspects depicted in those figures and other systems may be used to perform the method, as will be understood by those skilled in the art. It is to be appreciated that not all operations may be needed, and the operations may not be performed in the same order as shown in FIG. 10.

At 1002, the base station, such as the base station 104 of FIG. 1, receives a UE capability report from a UE, such as the UE 102 of FIG. 1. The UE capability report can indicate the UE capability 0, 1, 2, other capability.

At 1004, the base station generates a configuration message. In some aspects, the base station generates the configuration message based on the UE capability report. For example, the configuration message can assign a first set of antenna ports to the UE, such as the UE 102 of FIG. 1, and assign a second set of antenna ports to a second UE, such as the UE 106 of FIG. 1. If the UE reports the UE capability 0, the base station can refrain from assigning legacy antenna ports of a CDM group to the UE and assign new antenna ports of the CDM group to the second UE. For example, the UE may be in the enhanced DMRS configuration type 1 with 1 symbol, as discussed in FIG. 5A. The base station can assign the legacy antenna ports 0 and 1, which are in the CDM group 0, to the UE. In such a case, the base station can refrain from assigning the new antenna ports 8 and 9, which are also in the CDM group 0, to the second UE or any other UEs. However, if the UE reports the UE capability 1, the base station can assign the new antenna ports 8 and 9 to the second UE or other UEs.

At 1006, the base station transmits the configuration message to the UE. In some aspects, the base station can also transmit the configuration message to the second UE.

Various aspects can be implemented, for example, using one or more computer systems, such as computer system 1100 shown in FIG. 11. Computer system 1100 can be any well-known computer capable of performing the functions described herein such as devices 102, 104, and 106 of FIG. 1, or 200 of FIG. 2. Computer system 1100 includes one or more processors (also called central processing units, or CPUs), such as a processor 1104. Processor 1104 is connected to a communication infrastructure 1106 (e.g., a bus.) Computer system 1100 also includes user input/output device(s) 1103, such as monitors, keyboards, pointing devices, etc., that communicate with communication infrastructure 1106 through user input/output interface(s) 1102. Computer system 1100 also includes a main or primary memory 1108, such as random access memory (RAM). Main memory 1108 may include one or more levels of cache. Main memory 1108 has stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 reads from and/or writes to removable storage unit 1118 in a well-known manner.

According to some aspects, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LAN, WANs, the Internet, etc. Control logic and/or data may be transmitted to and from computer system 1100 via communication path 1126.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1100, main memory 1108, secondary memory 1110 and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 11. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a transceiver configured to enable wireless communications with a base station; and
a processor, communicatively coupled to the transceiver, and configured to:
receive, using the transceiver, a configuration message from the base station;
determine a first set of antenna ports based on the configuration message;
perform channel estimation on the first set of antenna ports; and
perform or refrain from performing interference estimation on a second set of antenna ports based on the configuration message,
wherein the first set of antenna ports and the second set of antenna ports are in a code division multiplexing (CDM) group.

2. The UE of claim 1, wherein the processor is further configured to:
determine a capability type of the UE, wherein the capability type indicates whether the UE supports the second set of antenna ports; and
perform or refrain from performing interference estimation on the second set of antenna ports based on the capability type and the configuration message.

3. The UE of claim 2, wherein the processor is further configured to:
generate a capability report based on the capability type of the UE; and
transmit, using the transceiver, the capability report to the base station.

4. The UE of claim 2, wherein the capability type further indicates whether the UE is a legacy UE or a new UE.

5. The UE of claim 2,
wherein the first set of antenna ports are legacy antenna ports,
wherein the second set of antenna ports are new antenna ports, and
wherein the processor is further configured to:
receive, using the transceiver, a second configuration message that includes a legacy antenna port table.

6. The UE of claim 5, wherein the processor is further configured to:
determine that that the capability type of the UE is capability 0 or default capability; and
refrain from performing interference estimation on the second set of antenna ports.

7. The UE of claim 1, wherein the processor is further configured to:
receive, using the transceiver, a second configuration message from the base station, wherein the second configuration message includes one or more sets of antenna ports;
determine that the one or more sets of antenna ports include the first set of antenna ports; and
in response to determining that the one or more sets of antenna ports include the first set of antenna ports, refrain from performing interference estimation on the second set of antenna ports.

8. The UE of claim 2, wherein the processor is further configured to:
determine that the capability type of the UE is capability 1;
determine that the first set of antenna ports are legacy antenna ports; and
perform interference estimation on the second set of antenna ports,
wherein the second set of antenna ports are new antenna ports.

9. The UE of claim 2, wherein the processor is further configured to:
determine that the capability type of the UE is capability 2;
determine that the first set of antenna ports are a combination of legacy antenna ports and new antenna ports; and
perform interference estimation on the second set of antenna ports,
wherein the second set of antenna ports are a combination of legacy antenna ports and new antenna ports.

10. A method of operating a user equipment (UE) comprising:
receiving a configuration message from a base station;
determining a first set of antenna ports based on the configuration message;
performing channel estimation on the first set of antenna ports; and
performing or refraining from performing channel estimation on a second set of antenna ports,
wherein the first set of antenna ports and the second set of antenna ports are in a code division multiplexing (CDM) group.

11. The method of claim 10, further comprising:
determining a capability type of the UE;
generating a capability report based on the capability type of the UE;
transmitting the capability report to the base station; and
performing or refraining from performing channel estimation on a second set of antenna ports based on the capability type of the UE.

12. The method of claim 10,
wherein the first set of antenna ports are legacy antenna ports,
wherein the second set of antenna ports are new antenna ports, and
wherein the configuration message includes a legacy antenna port table.

13. The method of claim 11, further comprising:
determining that that the capability type of the UE is capability 0 or default capability; and
refraining from performing channel estimation on the second set of antenna ports.

14. The method of claim 10, further comprising:
receiving a second configuration message from the base station, wherein the second configuration message includes one or more sets of antenna ports;
determining that the one or more sets of antenna ports include the first set of antenna ports; and
in response to determining that the one or more sets of antenna ports include the first set of antenna ports, refraining from performing channel estimation on the second set of antenna ports.

15. A base station comprising:
a transceiver configured to enable wireless communication with a first user equipment (UE) and a second UE; and
a processor, communicatively coupled to the transceiver, and configured to:
receive, using the transceiver, a capability report from the first UE;
generate a configuration message based on the capability report, wherein the configuration message assigns a first set of antenna ports to the first UE, wherein the configuration message further assigns a second set of antenna ports to the second UE or be vacant, and wherein the first and the second sets of antenna ports are in a code division multiplexing (CDM) group; and
transmit, using the transceiver, the configuration message to the first UE.

16. The base station of claim 15, wherein the first set of antenna ports are legacy antenna ports, and wherein the second set of antenna ports are new antenna ports.

17. The base station of claim 16, wherein the configuration message includes a legacy antenna port table.

18. The base station of claim 15, wherein the processor is further configured to:
generate a second configuration message that includes one or more sets of antenna ports;
determine that the one or more sets of antenna ports include the first set of antenna ports; and
generate the first configuration message to assign the second set of antenna ports to be vacant.

19. The base station of claim 15, wherein the first and the second sets of antenna ports are demodulation reference signals (DMRS) antenna ports.

20. The base station of claim 19,
wherein the first and the second sets of antenna ports are configuration type 1 or configuration type 2 DMRS antenna ports, and
wherein the first and the second sets of antenna ports are mapping type A or mapping type B DMRS antenna ports.
